(19) United States
(12) Patent Application Publication
(10) Pub. No.: US 2024/0423179 A1
(43) Pub. Date: Dec. 26, 2024

(54) Shape integrated into a fishing hook that allows for additional lines

(71) Applicant: Robert Gillingham, Boise, ID (US)

(72) Inventor: Robert Gillingham, Boise, ID (US)

(21) Appl. No.: 18/597,867

(22) Filed: Mar. 6, 2024

Related U.S. Application Data
(60) Provisional application No. 63/523,225, filed on Jun. 26, 2023.

(51) Int. Cl. A01K 83/00

(52) U.S. Cl. CPC A01K 83/00

(57) ABSTRACT

A shape on a fishing hook, wherein the shape can be anywhere on the fishing hook. The shape allows for the attachment of a separate fishing line equipped with an additional hook. The shape can be either a semi-eye, which is a nearly full loop, but with a gap in the nearly full loop, or a small notch, or a loop. All the shapes are built into the metal of the fishing hook, and can be either at the bottom of the bend of the fishing hook, or alternatively other places on the fishing hook, such that it is helpful for an angler to attach a separate line off the loop, and attach additional hooks and/or lures securely and conveniently.

### FIELD OF THE INVENTION

The present invention relates to the field of fishing hooks.

### BACKGROUND

The background description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties Such as concentration, reaction conditions, and so forth, used to describe and claim certain embodiments of the invention are to be understood as being modified in some instances by the term “about.”

Accordingly, in some embodiments, the numerical parameters set forth in the written description and attached claims are approximations that can vary depending upon the desired properties sought to be obtained by a particular embodiment.

In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an and “the includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “Such as”) provided with respect to certain embodiments herein is intended merely to better illuminate the invention and does not pose a limitation on the scope of the invention otherwise claimed.

No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any Such inclusion or deletion occurs, the specification is herein deemed to contain the group as modified thus fulfilling the written description of all Markush groups used in the appended claims.

An angler is a fisherman who uses the fishing technique of angling. Angling is a method of fishing by means of an angle. It is common for an angler to have many lures, flies, lines, and/or hooks while fishing. These lures, flies, lines and/or hooks can be “in-line”, as in they are put one after the other on the fishing line. A fishing hook with its parts is shown in FIGS. 1 and 2.

Several fishing hooks have a barb, which is a backward facing point on a fish hook, for the purpose of keeping the fish after it has been caught, such that the fish cannot wiggle out of the hook and get away. The barb can damage the fish's mouth, and this can be problematic if the fisherman intends to catch and release, which can be required in some places for some fish species with size restrictions, some regional bodies of waters, some times of year, and other similar types of restrictions. In fact, a barbless hook is the law in many states. A barb can also be harmful to the fisherman, because it is sharp and so the fisherman might injure themselves by impaling the barb in them, making it difficult and painful to remove.

Fisherman can adjust the barb by manually pinching the barb, or smashing it down with pliers or other tools, so that the fishing hook becomes barbless. A barbless hook is easier to remove from a fish's mouth, and is also easier to take out of a human in case the hook somehow got into a human. Anglers often lose their second line when they pinch barbs or fish with a manufactured barbless hook. This happens because there is nothing stopping the line from slipping off the bend of the hook, resulting in a loss of money from lost equipment, a loss of time from reattaching more hooks, and frustration from while trying to fish legally and safely.

When many hooks are tied in tandem, they are referred to as “in-line” or “stinger hooks” or “droppers” or “dropper hooks”. An example is shown in FIG. 3.

Such hooks can be relatively expensive to purchase (compared to other hooks), as displayed here: https://southfloridafishingchannel.com/products/stinger-rigs-1?variant=38034663702699&currency=USD&utm_medium=product_sync&utm_source=google&utm_content=sag_organic&utm_campaign=sag_organic

To enhance the angling experience and increase the chances of hooking and catching more fish, anglers will construct lures, flies, bait, and other methods of fishing with many hooks in-line. Examples are shown in FIGS. 4 through 6.

FIG. 6

Dry fly 601 is larger than dropper fly 603. Dry fly 601 is buoyant, so it floats above water. In contrast, dropper fly 603 is weighted, so that it will sink to some extent in the water. Tippet 602 is a fishing line that varies in length between 2.5 and 3 inches. Tippet 602 can be a thin strand of plastic or some kind of string or wire or any connection between two lures or baits. Tippet 602 can be translucent, or alternatively a light color or a color that blends with the water, like blue.

### SUMMARY

The present invention solves these issues, because the present invention makes it easier for anglers to attach many lures, flies, lines and/or hooks in-line while fishing. The present invention also allows for a hook to be truly barbless without the fear of the line falling off, which happens frequently.

The present invention involves adding a hook eye or semi-eye or other shape to the bend of the hook, or alternatively to any other location on the hook. This lets the angler attach a separate line off the hook eye or semi-eye or other shape, and attach additional hooks and/or lures securely and conveniently.

No product matching the present invention is presently for sale in the market. Thus, an angler can utilize a barbless lure or fly in accordance with some state laws or personal preferences.

### BRIEF DESCRIPTION OF THE DRAWINGS

Many aspects of the present disclosure can be better understood with reference to the attached drawings. The components in the drawings are not necessarily drawn to scale, with emphasis instead being placed upon clearly illustrating the principles of the disclosure. Moreover, in the drawings, like reference numerals designate corresponding parts throughout several views.

FIG. 1 is a drawing of a fishing hook.

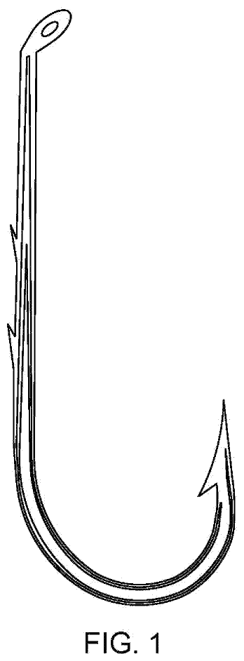

FIG. 2 is the same fishing hook as FIG. 1, but showing its different parts, and terminology for those parts.

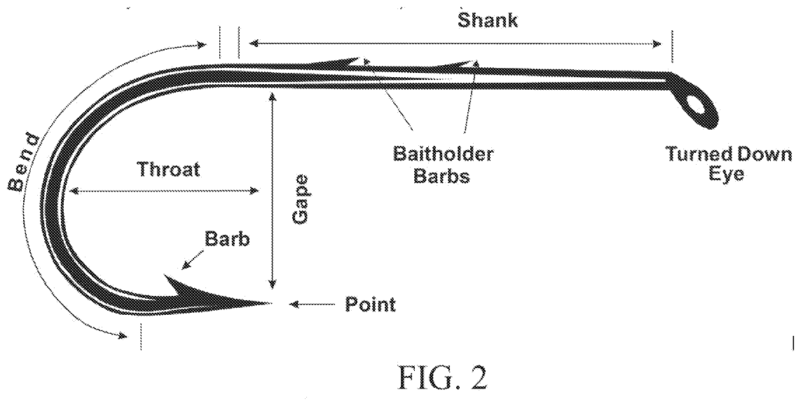

FIG. 3 is a drawing of stinger hooks typically used for bait fishing.

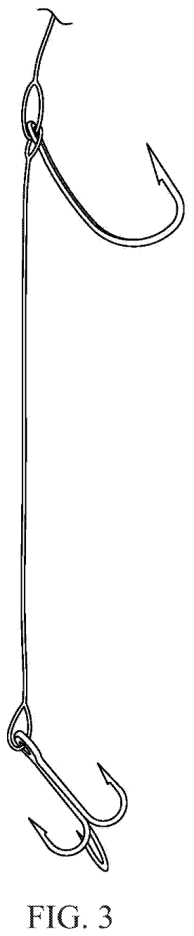

FIG. 4 is a drawing of an application of a stinger hook on or in a lure or bait.

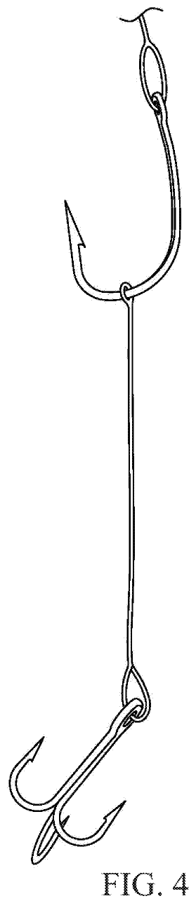

FIG. 5 is a drawing of a Goldie articulated streamer fly lure, which is a group of fly fishing lures called articulated streamers, where it is common to have two hooks in one lure or fly.

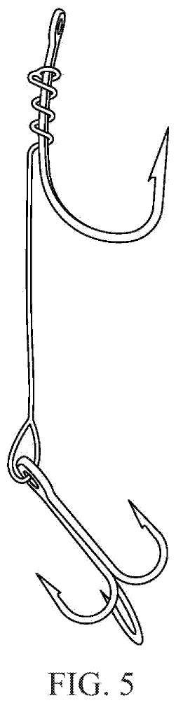

FIG. 6 is a drawing of a “dry dropper” setup for a fly lure.

FIG. 7 is a drawing of a fishing hook with an added semi-eye according to various embodiments of the present disclosure.

FIG. 8 is a drawing of a fishing hook with an added semi-eye according to various embodiments of the present disclosure.

FIG. 9 is a drawing of a fishing hook with an added semi-eye according to various embodiments of the present disclosure.

### DETAILED DESCRIPTION

Various embodiments of the present disclosure relate to providing a fishing hook with an added semi-eye.

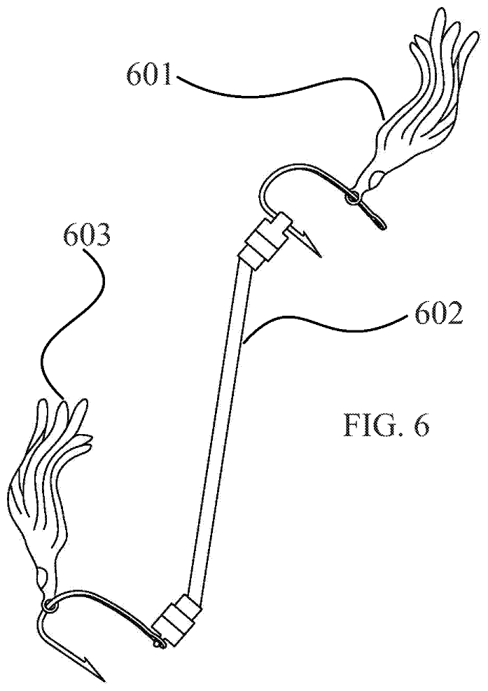

FIG. 6

One setup currently used is a “dry dropper” setup for a fly, as seen in FIG. 6. A dry dropper is a technique that fly fishermen utilize to present two fly lures at the same time. After being set up, there will be a surface fly and a subsurface fly under the water. The present invention's semi-eye would make this “dry dropper” setup easier. This is because attaching the dropper fly to a semi-eye would be more secure since the dropper fly would not easily fall off the semi-eye. In contrast, a dropper fly might easily fall off a barbless hook, costing the angler money from lost flies or lures, and time away from angling while re-tying an additional fly or lure. Also, attaching the dropper fly to a semi-eye would be faster than attaching a dropper fly to a barbless hook, because the dropper fly would attach to the hole created by the semi-eye in one motion. Furthermore, if the hook had a barb, the angler would have to push down the barb to make the hook barbless, and risk losing the dropper fly.

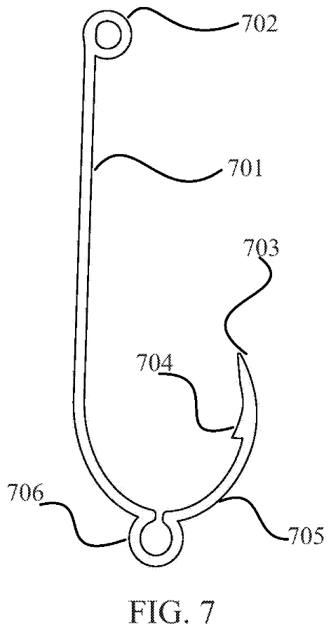

FIG. 7

FIG. 7 is a drawing of a fishing hook with an added semi-eye according to various embodiments of the present disclosure. It shows the semi-eye in the middle of the bend. This semi-eye is manufactured using the same wire as with the rest of the hook, and so there is no danger of this semi-eye falling off the hook. The fishing hook also has an eye, a shank, a bend, a point, and no barb.

There is no such hook with a semi-eye on the market as of today.

Shank 701 is a straight metal piece, attached to bend 705. Semi-eye 706 shows the new aspect of the present invention. Barb 704 and point 703 are also part of the fishing hook. Eye 702 can be utilized to attached to a dry fly or other buoyant fly, or can be attached to the fishing line, or however the fisherman chooses to utilize eye 702.

In alternative embodiments, the semi-eye does not have to be circular, it could be square like, or other shapes, as long as a fishing line or fly lure is unlikely to come out of it. Other alternative semi-eye shapes include any changes to the fishing hook's shape that aids in holding or retaining a fishing line for additional hooks or additional lures. Such alternative shapes include any kind of notch or bend or partial loop or full loop that aids an angler in attaching a fishing line.

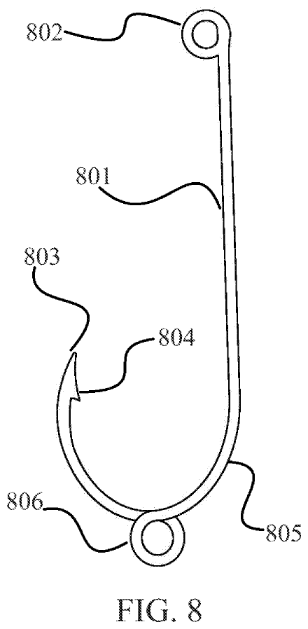

FIG. 8

FIG. 8 is a drawing of a fishing hook according to various embodiments of the present disclosure. The fishing hook has a bend in the shape of a loop at the bottom of the bend in the fishing hook. This loop accomplishes the same goal as the semi-eye above, because the angler can attach a separate line off the loop, and attach additional hooks and/or lures securely and conveniently. No such product currently exists in the marketplace.

Shank 801 is a straight metal piece, attached to bend 805. Looped semi-eye 806 shows the new aspect of the present invention. Barb 804 and point 803 are also part of the fishing hook. Eye 802 can be utilized to attached to a dry fly or other buoyant fly, or can be attached to the fishing line, or however the fisherman chooses to utilize eye 802.

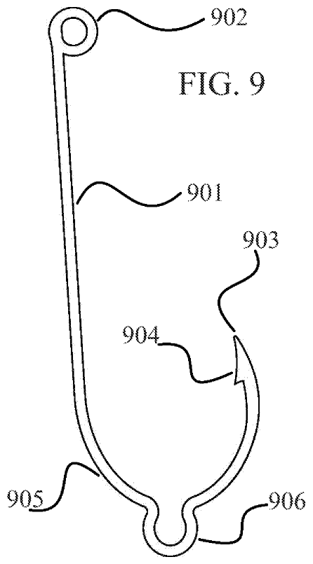

FIG. 9

FIG. 9 is a drawing of a fishing hook according to various embodiments of the present disclosure. The fishing hook has a small notch at the bottom of the bend in the fishing hook. This small notch accomplishes the same goal as the semi-eye above, because the angler can attach a separate line off the loop, and attach additional hooks and/or lures securely and conveniently. No such product currently exists in the marketplace.

Shank 901 is a straight metal piece, attached to bend 905. Notch 906 shows the new aspect of the present invention. Barb 904 and point 903 are also part of the fishing hook. Eye 902 can be utilized to attached to a dry fly or other buoyant fly, or can be attached to the fishing line, or however the fisherman chooses to utilize eye 902.

In alternative embodiments, the fishing hook can be made of any type of metal. Some metals will be able to withstand freshwater, while other metals will be more suitable to saltwater and able to withstand saltwater.

In the following embodiments, designated by letter, each embodiment may be combined with 1 or more of the other embodiments in any order:

Embodiment A: A semi-eye on a fishing hook, wherein the semi-eye is a nearly full loop, but with a gap in the nearly full loop; wherein the fishing hook either has a barb or does not have a barb; wherein the semi-eye can be anywhere on the fishing hook; wherein the semi-eye allows for attachment of a separate fishing line from a line that the fishing hook is on; and wherein the separate fishing line is attached to a separate fishing hook.

Embodiment B: The semi-eye on a fishing hook of Embodiment A, further comprising: wherein the separate fishing line is attached to a dropper fly; wherein the dropper fly is at any length or depth from the semi-eye on the separate fishing line away from the semi-eye; wherein there is a separate fishing hook attached to the semi-eye of the hook being attached to the head of the dropper fly.

Embodiment C: The semi-eye on a fishing hook of Embodiment A, further comprising: wherein the semi-eye is at a point of the fishing hook where a throat is at a maximum.

Embodiment D: The semi-eye on a fishing hook of Embodiment A, further comprising: wherein the fishing hook can be made of any metal.

Embodiment E: The semi-eye on a fishing hook of Embodiment A, further comprising: wherein the semi-eye is at a point of the fishing hook where a throat is at a maximum; wherein the separate fishing line is attached to a dropper fly; wherein the dropper fly is at any length or depth from the separate fishing line away from the semi-eye; wherein there is a separate fishing hook attached to the semi-eye of the hook being attached to the head of the dropper fly; and wherein the fishing hook can be made of any metal.

Embodiment F: A shape on a fishing hook, wherein the shape can be anywhere on the fishing hook; wherein the shape is attached to a separate fishing line from a line that the fishing hook is on; and wherein the fishing hook can be made of any metal.

Embodiment G: The semi-eye on a fishing hook of Embodiment F, further comprising: wherein the shape is either a small notch, or a loop such that the metal of the bend of the fishing hook loops around and continues along the bend, or a nearly full loop, but with a gap in the nearly full loop.

Embodiment H: The semi-eye on a fishing hook of Embodiment F, further comprising: wherein the semi-eye is at a lowest point of the fishing hook, where a throat is at a maximum.

Embodiment I: A shape on a fishing hook, wherein the fishing hook either has a barb or does not have a barb; wherein the shape can be anywhere on a bend of the fishing hook; wherein the shape is attached to a separate fishing line from a line that the fishing hook is on; wherein the separate fishing line is attached to a separate fishing hook.

Embodiment J: The shape on a fishing hook of Embodiment I, further comprising: wherein the shape is a small notch.

Embodiment K: The shape on a fishing hook of Embodiment J, further comprising: wherein the separate fishing line is attached to a dropper fly; wherein the dropper fly is at any length or depth from the semi-eye on the separate fishing line away from the small notch; wherein there is a separate fishing hook attached to the small notch of the hook being attached to the head of the dropper fly.

Embodiment L: The shape on a fishing hook of Embodiment J, further comprising: wherein the small notch is at a lowest point of the fishing hook, where a throat is at a maximum.

Embodiment M: The shape on a fishing hook of Embodiment J, further comprising: wherein the fishing hook can be made of any metal.

Embodiment N: The shape on a fishing hook of Embodiment J, further comprising: wherein the small notch is at a lowest point of the fishing hook, where a throat is at a maximum; wherein the separate fishing line is attached to a dropper fly; wherein the dropper fly is at any length or depth from the small notch on the separate fishing line away from the small notch; wherein there is a separate fishing hook at a head of the dropper fly and another separate fishing hook at a tail of the dropper fly; and wherein the fishing hook can be made of any metal.

Embodiment O: The shape on a fishing hook of Embodiment I, further comprising: wherein the shape is a loop such that the metal of the bend of the fishing hook loops around and continues along the bend.

Embodiment P: The shape on a fishing hook of Embodiment O, further comprising: wherein the separate fishing line is attached to a dropper fly; wherein the dropper fly is at any length or depth from the loop on the separate fishing line away from the loop; wherein there is a separate fishing hook at a head of the dropper fly and another separate fishing hook at a tail of the dropper fly.

Embodiment Q: The shape on a fishing hook of Embodiment O, further comprising: wherein the loop is at a lowest point of the fishing hook, where a throat is at a maximum.

Embodiment R: The shape on a fishing hook of Embodiment O, further comprising: wherein the fishing hook can be made of any metal.

Embodiment S: The shape on a fishing hook of claim 15, further comprising: wherein the loop is at a lowest point of the fishing hook, where a throat is at a maximum; wherein the separate fishing line is attached to a dropper fly; wherein the dropper fly is at any length or depth from the loop on the separate fishing line away from the loop; wherein there is a separate fishing hook at a head of the dropper fly and another separate fishing hook at a tail of the dropper fly; and wherein the fishing hook can be made of any metal.

Embodiment T: The shape on a fishing hook of claim 9, further comprising: wherein the shape is a nearly full loop, but with a gap in the nearly full loop; wherein the shape is at a lowest point of the fishing hook, where a throat is at a maximum; and wherein the fishing hook can be made of any metal.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A semi-eye on a fishing hook,
wherein the semi-eye is a nearly full loop, but with a gap in the nearly full loop;
wherein the fishing hook either has a barb or does not have a barb;
wherein the semi-eye can be anywhere on the fishing hook;
wherein the semi-eye allows for attachment of a separate fishing line from a line that the fishing hook is on; and
wherein the separate fishing line is attached to a separate fishing hook.

2. The semi-eye on a fishing hook of claim 1, further comprising:
wherein the separate fishing line is attached to a dropper fly;
wherein the dropper fly is at any length or depth from the semi-eye on the separate fishing line away from the semi-eye;
wherein there is a separate fishing hook attached to the semi-eye of the hook being attached to the head of the dropper fly.

3. The semi-eye on a fishing hook of claim 1, further comprising:
wherein the semi-eye is at a point of the fishing hook where a throat is at a maximum.

4. The semi-eye on a fishing hook of claim 1, further comprising:
wherein the fishing hook can be made of any metal.

5. The semi-eye on a fishing hook of claim 1, further comprising:
wherein the semi-eye is at a point of the fishing hook where a throat is at a maximum;
wherein the separate fishing line is attached to a dropper fly;
wherein the dropper fly is at any length or depth from the separate fishing line away from the semi-eye;
wherein there is a separate fishing hook attached to the semi-eye of the hook being attached to the head of the dropper fly; and
wherein the fishing hook can be made of any metal.

6. A semi-eye on a fishing hook,
wherein the shape can be anywhere on the fishing hook;
wherein the shape is attached to a separate fishing line from a line that the fishing hook is on; and
wherein the fishing hook can be made of any metal.

7. The semi-eye on a fishing hook of claim 6, further comprising:
wherein the shape is either a small notch, or a loop such that the metal of the bend of the fishing hook loops around and continues along the bend, or a nearly full loop, but with a gap in the nearly full loop.

8. The semi-eye on a fishing hook of claim 6, further comprising:
wherein the semi-eye is at a lowest point of the fishing hook, where a throat is at a maximum.

9. A shape on a fishing hook,
wherein the fishing hook either has a barb or does not have a barb;
wherein the shape can be anywhere on a bend of the fishing hook;
wherein the shape is attached to a separate fishing line from a line that the fishing hook is on;
wherein the separate fishing line is attached to a separate fishing hook.

10. The shape on a fishing hook of claim 9, further comprising:
Wherein the shape is a small notch.

11. The shape on a fishing hook of claim 10, further comprising:
wherein the separate fishing line is attached to a dropper fly;
wherein the dropper fly is at any length or depth from the semi-eye on the separate fishing line away from the small notch;
wherein there is a separate fishing hook attached to the small notch of the hook being attached to the head of the dropper fly.

12. The shape on a fishing hook of claim 10, further comprising:
wherein the small notch is at a lowest point of the fishing hook, where a throat is at a maximum.

13. The shape on a fishing hook of claim 10, further comprising:
wherein the fishing hook can be made of any metal.

14. The shape on a fishing hook of claim 10, further comprising:
wherein the small notch is at a lowest point of the fishing hook, where a throat is at a maximum;
wherein the separate fishing line is attached to a dropper fly;
wherein the dropper fly is at any length or depth from the small notch on the separate fishing line away from the small notch;
wherein there is a separate fishing hook at a head of the dropper fly and another separate fishing hook at a tail of the dropper fly; and
wherein the fishing hook can be made of any metal.

15. The shape on a fishing hook of claim 9, further comprising:
wherein the shape is a loop such that the metal of the bend of the fishing hook loops around and continues along the bend.

16. The shape on a fishing hook of claim 15, further comprising:
wherein the separate fishing line is attached to a dropper fly;
wherein the dropper fly is at any length or depth from the loop on the separate fishing line away from the loop;
wherein there is a separate fishing hook at a head of the dropper fly and another separate fishing hook at a tail of the dropper fly.

17. The shape on a fishing hook of claim 15, further comprising:
wherein the loop is at a lowest point of the fishing hook, where a throat is at a maximum.

18. The shape on a fishing hook of claim 15, further comprising:
wherein the fishing hook can be made of any metal.

19. The shape on a fishing hook of claim 15, further comprising:
wherein the loop is at a lowest point of the fishing hook, where a throat is at a maximum;
wherein the separate fishing line is attached to a dropper fly;
wherein the dropper fly is at any length or depth from the loop on the separate fishing line away from the loop;
wherein there is a separate fishing hook at a head of the dropper fly and another separate fishing hook at a tail of the dropper fly; and
wherein the fishing hook can be made of any metal.

20. The shape on a fishing hook of claim 9, further comprising:
wherein the shape is a nearly full loop, but with a gap in the nearly full loop;
wherein the shape is at a lowest point of the fishing hook, where a throat is at a maximum; and
wherein the fishing hook can be made of any metal.
